(19) United States
(12) Patent Application Publication
(10) Pub. No.: US 2026/0346440 A1
(43) Pub. Date: Nov. 5, 2026

(54) MOBILE ROBOT POWER CONTROL APPARATUS, SYSTEM AND METHOD

(71) Applicants: Hyundai Motor Company, Seocho-gu (KR); Kia Corporation, Seocho-gu (KR)

(72) Inventors: Seung Woo PARK, Gyeonggi-do (KR); In Ho SUNG, Gyeonggi-do (KR); Sung Hyun KIM, Gyeonggi-do (KR); Kye Un AHN, Gyeonggi-do (KR); Woo Hyung LEE, Gyeonggi-do (KR); Young Jin JUNG, Gyeonggi-do (KR); Kyung Hwa KANG, Gyeonggi-do (KR); Beom Jun LEE, Gyeonggi-do (KR)

(21) Appl. No.: 19/398,184

(22) Filed: Nov. 24, 2025

(30) Foreign Application Priority Data
May 2, 2025 (KR) 10-2025-0058317

(51) Int. Cl. B25J 9/16; B25J 19/00

(52) U.S. Cl. CPC B25J 9/1653; B25J 9/1682; B25J 19/005

(57) ABSTRACT

A mobile robot power control apparatus, system, and method, capable of partially or fully controlling supply of power of a mobile robot based on an operational state of the mobile robot. A mobile robot power control apparatus includes a first processor that controls supply of power to a drive unit of a mobile robot, a battery management system that performs the supply of power to the mobile robot, and a second processor that controls an operation of the battery management system, in which at least one of the first processor or the second processor cuts off the supply of power to the drive unit, based on an operational state of the mobile robot.

### CROSS-REFERENCE TO RELATED APPLICATION

Pursuant to 35 U.S.C. § 119(a), this application claims the benefit of an earlier filing date and right of priority to Korean Patent Application No. 10-2025-0058317 filed on May 2, 2025, the entire contents of which are incorporated herein by reference.

### TECHNICAL FIELD

The present disclosure relates to a mobile robot power control apparatus.

### BACKGROUND

In order to improve the efficiency of factory automation and logistics systems, mobile robots, such as automated guided vehicles (AGVs) or autonomous mobile robots (AMRs), are being used in various industrial settings. Such a mobile robot performs tasks such as repetitive logistics transfer or production assistance, and in general, multiple mobile robots are operated simultaneously.

### SUMMARY

In one aspect, the present disclosure provides a mobile robot power control apparatus including a first processor that controls supply of power to a drive unit of a mobile robot, a battery management system that performs the supply of power to the mobile robot, and a second processor that controls an operation of the battery management system, in which at least one of the first processor or the second processor cuts off the supply of power to the drive unit, based on an operational state of the mobile robot.

In an implementation, based on determining that the operational state of the mobile robot is a standby state and the standby state is maintained for more than a reference time, the first processor may control a drive relay connected to the drive unit and cut off the supply of power to the drive unit.

In another implementation, in a state where the supply of power to the drive unit is cut off, the second processor may monitor a power state of the mobile robot, and may transmit a signal to the first processor so that the supply of power to the drive unit is re-started based on the power state of the mobile robot.

In still another implementation, based on determining that the power state is equal to or lower than a predetermined threshold, the first processor may re-start the supply of power to the drive unit to perform a charging mode of the mobile robot.

In yet another implementation, based on determining that the operational state of the mobile robot is a task execution state, the first processor may perform control so that the supply of power to the drive unit is not cut off to maintain the supply of power to the drive unit.

In another aspect, the present disclosure provides a mobile robot power control system including a first processor that controls supply of power to a drive unit of a mobile robot, a battery management system that manages the supply of power to the mobile robot, a second processor that controls an operation of the battery management system, and a server that controls the first processor and the second processor, in which at least one of the first processor or the second processor cuts off the supply of power to the drive unit according to a control command of the server based on an operational state of the mobile robot.

In an implementation, the server may transmit, to a plurality of mobile robots, a command for controlling the plurality of mobile robots in a batch.

In another implementation, based on determining that the operational state of the mobile robot is a task execution state, the server may maintain the supply of power to the drive unit by not transmitting a power-off command to the first processor.

In still another implementation, based on determining that the operational state of the mobile robot is a standby state and the standby state is maintained for more than a first reference time, the server may transmit a power-off command for cutting off the supply of power to the drive unit, and the first processor may control a drive relay connected to the drive unit based on the power-off command to cut off the supply of power to the drive unit.

In yet another implementation, based on determining that the operational state of the mobile robot is a standby state, and the standby state is maintained for more than a second reference time and is a long-term suspended state, the server may transmit a power-off command for cutting off the supply of power to the drive unit, the first processor may control a drive relay connected to the drive unit based on the power-off command, to cut off the supply of power to the drive unit, and the second processor may control the battery management system based on the power-off command to cut off the supply of power from a battery to the drive unit.

In still yet another implementation, based on determining that the operational states of all the plurality of mobile robots are suspended and the suspended states are maintained for more than a third reference time, the server may transmit a power-off command for cutting off power of the mobile robots to each of the plurality of mobile robots.

In a further implementation, the server may output information on the power supply cut-off of the plurality of mobile robots to a user.

In another further implementation, the server may periodically monitor, in a state where at least one of the supply of power to the drive unit or the operation of the battery management system is controlled, a power state of the mobile robot.

In still another further implementation, based on determining that the power state is equal to or lower than a predetermined threshold, the server may transmit a control command to the first processor to supply power to the drive unit, and may perform control for charging the mobile robot.

In yet another further implementation, in a case where the operational state of the mobile robot transitions from a standby state to a task execution state, the server may transmit a control command instructing supply of power to the drive unit, the first processor may control a drive relay connected to the drive unit based on the control command instructing supply of power to supply power to the drive unit, and the second processor may control the battery management system based on the control command instructing supply of power to supply power from a battery to the drive unit.

In still another aspect, the present disclosure provides a mobile robot power control method including receiving an operational state and a power state of each of a plurality of mobile robots, by a processor, generating a control command for controlling at least one of supply of power to a drive unit of the mobile robot or an operation of a battery management system of the mobile robot, based on the received operational state or power state, by the processor, and transmitting the control command to a specific mobile robot or all of the plurality of mobile robots, by the processor.

In an implementation, the generating the control command may include generating, based on determining that the operational state of the mobile robot is a standby state and the standby state is maintained for more than a reference time, a control command for cutting off the supply of power to the drive unit of the mobile robot, or a control command for cutting off supply of power to remaining components except a communication module included in the mobile robot by controlling the operation of the battery management system of the mobile robot.

In another implementation, the generating the control command may further include transmitting, based on determining that the operational states of the plurality of mobile robots are suspended and the suspended states are maintained for more than a reference time, a power-off command for cutting off power of all the plurality of mobile robots to each of the plurality of mobile robots.

In still another implementation, the generating the control command may further include generating, based on determining that the operational state of the mobile robot transitions from the standby state to a task execution state, a control command for supplying power to the drive unit.

In yet another implementation, the generating the control command may further include starting a charging mode for the mobile robot, based on determining that the power state falls below a threshold.

Other aspects and implementations of the disclosure are discussed infra.

### BRIEF DESCRIPTION OF THE DRAWINGS

The above and other features of the present disclosure will now be described in detail with reference to certain exemplary implementations thereof illustrated the accompanying drawings which are given hereinbelow by way of illustration only, and thus are not limitative of the present disclosure, and wherein:

FIG. 1 is a diagram showing an example of a block configuration of a mobile robot power control apparatus according to an implementation of the present disclosure;

FIG. 2 is a diagram illustrating an example of a mobile robot power control apparatus according to an implementation of the present disclosure;

FIG. 3 is a diagram showing an example of a block configuration of a mobile robot power control system according to an implementation of the present disclosure;

FIG. 4 is a diagram illustrating an example of a mobile robot power control system according to an implementation of the present disclosure;

FIGS. 5 - 7 are diagrams showing an example of a mobile robot power control system according to an implementation of the present disclosure; and

FIGS. 8 and 9 are flowcharts illustrating an example of a mobile robot power control method according to an implementation of the present disclosure.

### DETAILED DESCRIPTION

Implementations of the present disclosure can provide a mobile robot power control apparatus that automatically manages power consumption in an operation of a large number of mobile robots, and a system and method therefor.

In scenarios where a mobile robot is operated by battery power, even in a standby state in which no work is being performed, a certain level of power required for system maintenance is continuously consumed. In particular, when production processes are paused, lines are deliberately stopped, or factories are closed, mobile robots may enter an extended standby mode, which causes unnecessary power consumption, thereby lowering overall energy efficiency of the industrial site.

In some cases, techniques can be used for manually controlling power of the mobile robot individually or utilizing a power saving function inside the mobile robot. However, such techniques can make energy conservation difficult, because they often require human intervention, and in large-scale industrial sites with many mobile robots, this may lead to inefficient management and increased operating costs.

Some power saving functions merely provide a single power saving mode or simply operate in a time-based manner, which does not consider the diversity of real operating environments. As a result, it is difficult to sufficiently prevent the risk of battery discharge when the mobile robot is in a long-term standby state. Furthermore, there are limitations in terms of energy management and maintenance of mobile robots due to the absence of an automatic return function by an external command.

According to implementations of the present disclosure, it is possible to effectively suppress unnecessary power consumption in standby or suspended situations where no task is being executed. For example, this can be achieved by selectively controlling the operation of the drive unit and the battery management system based on the operational state and the power state of the mobile robot. In some implementations, by controlling the supply of power to the drive unit and the battery management system in multiple stages, it is possible to switch the system to an appropriate power saving mode according to various operating scenarios such as a standby state, a long-term suspended (inactive) state, and a system-wide shutdown state, thereby improving the energy efficiency of the entire system.

In addition, a server can receive and analyze the operational state and power state of each mobile robot, e.g., in real time, to automatically control power saving mode entry, charging mode switching, and returning to task. As such, this can enable stable performance of power management of the mobile robot without human intervention. Furthermore, the communication module can maintain the operational state even in the power cutoff state, and thus it is possible to perform automatic return through external command reception even in the long-term power saving state. Accordingly, it is possible to provide the mobile robot power control apparatus, system, and method capable of saving energy and ensuring continuous operation of the system.

Reference will hereinafter be made in detail to various implementations of the present disclosure, examples of which are illustrated in the accompanying drawings and described below. While the disclosure will be described in conjunction with exemplary implementations, it will be understood that present description is not intended to limit the disclosure to the exemplary implementations. On the contrary, the disclosure is intended to cover not only the exemplary implementations, but also various alternatives, modifications, equivalents and other implementations, which may be included within the spirit and scope of the disclosure as defined by the appended claims. It should be further understood that the terms “comprise”, “include”, and/or “comprising”, “including” used herein merely specify the presence of stated features, numbers, steps, operations, components, parts, or combinations thereof, but do not preclude the presence or addition of one or more other features, numbers, steps, operations, components, parts, or combinations thereof.

In addition, in order to facilitate understanding of the disclosure, the accompanying drawings are not drawn to true scale, and the sizes of certain components may be exaggerated. Wherever possible, the same reference numbers will be used throughout the drawings to refer to the same or like parts.

That two comparators are “identical” means that they are “substantially identical”. Therefore, substantial identity may include cases where variations are considered slight in the art, for example, a deviation of 5% or less. In addition, when a certain parameter is described as uniform in a given region, it may mean that it is uniform from an average perspective.

It will be understood that, although the terms “first”, “second”, etc. may be used herein to describe various elements, these elements should not be limited by these terms. These terms are only used to distinguish one element from another, and a first component may be replaced with a second component, unless specifically stated otherwise.

Throughout the specification, each component may be singular or plural, unless explicitly stated otherwise.

When a specific element is disposed “above (or below)” an element or “on (or under)” an element, it may mean not only that the specific element is disposed in contact with an upper surface (or lower surface) of the element, but also that another element may be interposed between the element and the specific element disposed above (or below) the element.

In addition, it will be understood that, when an element is “connected” or “coupled” to another element, it may be directly connected or coupled to the other element, or may be indirectly connected or coupled to the other element with a different element being interposed therebetween. In contrast, when an element is “electrically coupled” to another element, it may be directly coupled to the other element, or may be coupled to the other element with a different element being interposed therebetween.

When “A and/or B” is used throughout this specification, it means A, B, or A and B, unless explicitly stated otherwise. That is, “and/or” includes all combinations or any combination of the plural items listed. When “C to D” is used, it means a range that is equal to or greater than C and equal to or less than D, unless explicitly stated otherwise.

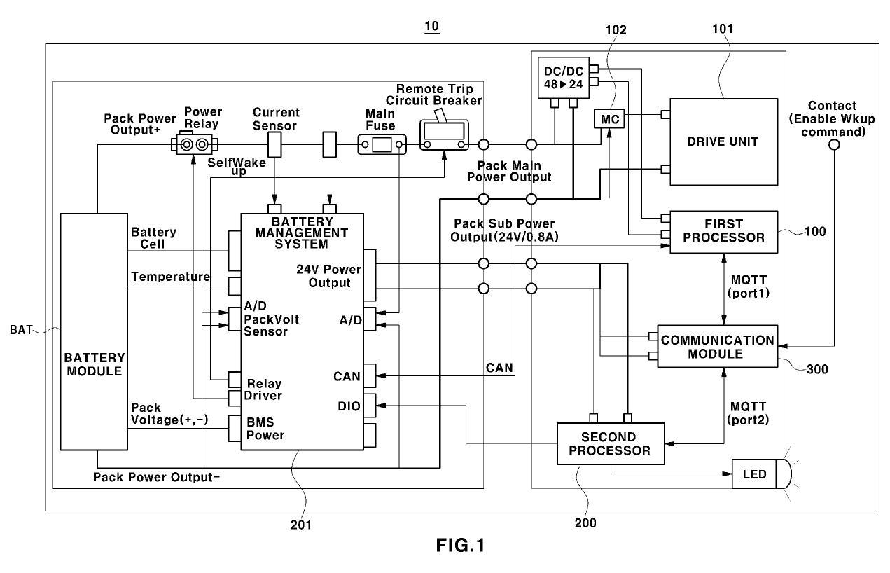

FIG. 1 is a diagram showing an example of a block configuration of a mobile robot power control apparatus according to an implementation of the present disclosure. Referring to FIG. 1, the mobile robot power control apparatus according to the present implementation may include at least one processor, such as first processor 100 and second processor 200, and a communication module 300.

The different processors can control different aspects of the mobile robot power control. For example, the first processor 100 can control the supply of power to a drive unit 101. In such scenarios, the first processor 100 can control a power supply on/off of the drive unit 101, for example, by controlling a drive relay 102 based on an operational state of a mobile robot 10.

As another example, the second processor 200 can control an operation of a battery management system 201. In such scenarios, the second processor 200 may control the power transmitted to respective components (for example, sensors, control units, or the like) of the mobile robot 10 from a battery module (BAT), based on the operational state of the mobile robot 10. The second processor 200 may determine the supply of power to each component by controlling a digital output (DIO) circuit of the battery management system 201, and the second processor 200 according to the present implementation may be implemented in the form of an advanced data acquisition module (ADAM), which is a commercial module, for example.

The various implementations herein may be implemented by software including one or more commands stored in a storage medium (for example, a built-in memory or an external memory) readable by a machine (for example, a computing device or processor (100, 200)). For example, the computing device or processor (100, 200) may call at least one of the one or more commands stored from the storage medium, and may execute the called command. The at least one command may include code generated by a compiler or code that may be executed by an interpreter. The storage medium readable by the computing device or processor (100, 200) may be provided in the form of a non-transitory storage medium. Here, the “non-transitory” means that the storage medium is tangible and does not include a signal (for example, electromagnetic waves). This term does not distinguish between a case where data is stored semi-permanently on a storage medium and a case where data is temporarily stored thereon.

The processor (100, 200) may include hardware (for example, a controller, or the like) for implementing the above-mentioned various implementations. The processor (100, 200) may include one or more cores, and may be a processor for data analysis and deep learning, such as a central processing unit (CPU), a general purpose graphics processing unit (GPGPU), a tensor processing unit (TPU), an application processor (AP), an application specific Integrated circuit (ASIC), or a field programmable gate array (FPGA). The processor for deep learning may perform control for processing input data according to predefined operation rules or artificial intelligence models stored in a memory. In a case where one or more processors are dedicated to artificial intelligence, the artificial intelligence dedicated processors may be designed with a hardware structure that is specialized for processing of a specific artificial intelligence model.

The memory may store various information and maps necessary to implement the various implementations described herein. The memory may include at least one type storage medium among a flash memory, a hard disk, a multimedia card micro type memory, a card type memory (such as an SD or an XD memory), a random access memory (RAM), a static random access memory (SRAM), a dynamic random access memory (DRAM), a magnetic random access memory (MRAM), a read-only memory (ROM), an electrically erasable programmable read-only memory (EEPROM), a programmable read-only memory (PROM), a magnetic memory, a magnetic disk, and an optical disc. In addition, the memory may include any form of computer readable recording medium known in the technical field associated with the present disclosure. Further, examples of the storage media or recording media may include media managed by application stores that distribute applications, or other sites, servers, etc. that supply or distribute various software. The above-mentioned memory is an example only, and the present disclosure is not limited thereto.

The drive unit 101 may control the supply of power according to a control command of at least one processor, such as the first processor 100. The drive unit 101 may include a drive motor or a driving system to perform movement or steering of the mobile robot 10. The drive unit 101 may be implemented based on a drive unit known in the field of autonomous robots, and a specific description thereof will be omitted.

The drive relay 102 may include a relay circuit for on/off control of the supply of power to the drive unit 101 under the control of the first processor 100. The drive relay 102 may correspond to a switching element provided on a power supply path to the drive unit 101, and may perform switching operations in accordance with a control signal of the first processor 100. Here, the drive relay 102 may be implemented as an FET based switching circuit or a motor controller (MC).

The battery management system 201 may monitor a state of the battery module (BAT) mounted on the mobile robot 10, and may control the supply of power to each component included the mobile robot 10. The battery management system 201 according to an example of the present implementation may be operated under the control of the at least one processor, such as the second processor 200, and may be connected to the second processor 200 via a digital input/output (DIO) circuit. Through this connection, a flow of power from the battery module (BAT) to each component included in the mobile robot 10 may be controlled.

The battery module (BAT) may correspond to an energy storage that stores and supplies main power for the operation of the mobile robot 10. The battery module (BAT) may be implemented in a variety of forms, such as a lithium-ion battery or a lithium-polymer battery. The battery module (BAT) may be implemented as a power supply used in the field of autonomous robots, and description of its specific structure and control method will be omitted.

The communication module 300 may perform communication between different processors, such as the first processor 100 and the second processor 200. The communication module 300 may transmit and receive an operational state and a power state of the mobile robot 10 through wireless or wired communication with a higher-level control unit or server. The communication module 300 according to the present implementation may perform, for example, message queuing telemetry transport (MQTT) protocol-based communication between the first processor 100 and the second processor 200. As a specific example, the communication module 300 may perform communication with the first processor 100 through an MQTT port (port 1) and perform communication with the second processor 200 through an MQTT port (port 2) to transmit and receive state information and control commands between the processors. In some implementations, the communication module 300 may be supplied with power independently even in a long-term suspended state of the mobile robot 10, which will be described later.

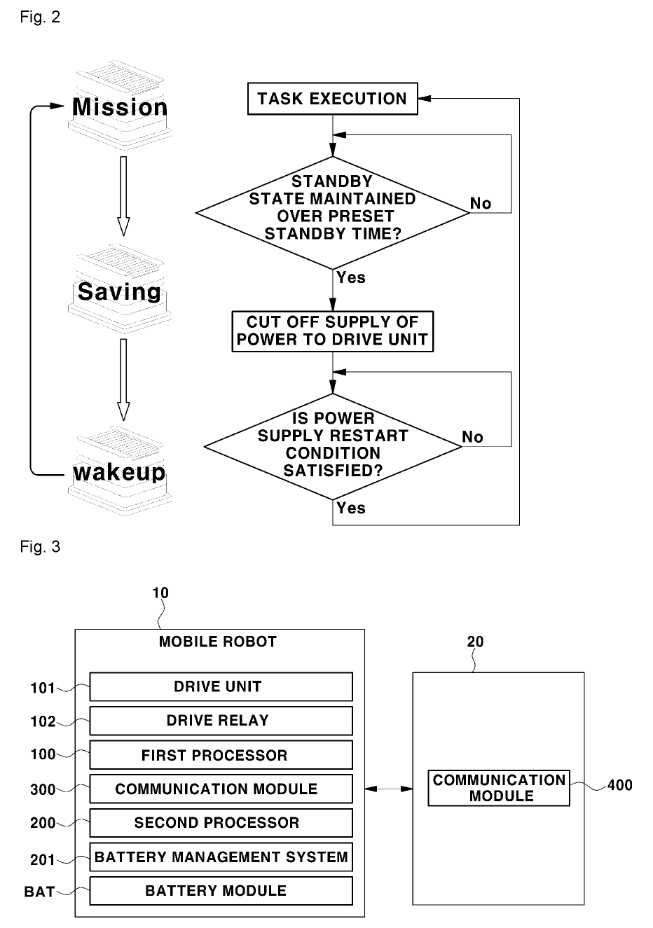

FIG. 2 is a diagram illustrating an example of a mobile robot power control apparatus according to an implementation of the present disclosure. Referring to FIG. 2, in the mobile robot power control apparatus according to the present implementation, based on the operational state of the mobile robot 10, at least one processor, such as the first processor 100 and/or the second processor 200, may control at least one of the supply of power to the drive unit 101 or the operation of the battery management system 201.

Here, the operational state of the mobile robot 10 may be classified into various states, for example, a task execution state, a standby state, a long-term suspended state, or a system-wide shutdown state.

For example, based on determining that the current operational state of the mobile robot 10 is the standby state and the standby state is maintained for more than a reference time, the first processor 100 may cut off the supply of power to the drive unit 101. Specifically, the first processor 100 may control the drive relay 102 connected to the drive unit 101, to thereby cut off the supply of power to the drive unit 101. The drive relay 102 may open (OFF) or close (ON) the relay depending on a signal of the first processor 100 (for example, ON/OFF signal, pulse). In scenarios where the drive relay 102 is opened, since a power supply line is opened so that current output from the battery module (BAT) does not flow, the supply of power to the drive unit 101 is physically cut off.

When the supply of power to the drive unit 101 is cut off by the first processor 100, the second processor 200 may monitor the power state of the mobile robot 10. The second processor 200 may receive data such as information on the power state of the mobile robot 10 transmitted from the battery management system 201, for example, a state of charge (SOC), a voltage state, or a temperature state. Based on the received data, the second processor 200 may determine whether the power state of the mobile robot 10 is within a safe operation range.

The second processor 200 may transmit a signal to the first processor 100 so that the supply of power to the drive unit 101 can be re-started, based on the power state of the mobile robot 10. For example, based on determining that the power state is equal to or lower than a threshold, the second processor 200 may determine that the mobile robot 10 needs to be charged. The second processor 200 may transmit a control signal or a trigger signal to the first processor 100 to initiate charging for the mobile robot 10.

According to the signal received from the second processor 200, the first processor 100 may re-start the supply of power to the drive unit 101 to initiate the charging mode of the mobile robot 10. The charging mode of the mobile robot 10 may include arrival at a predetermined charging location of the mobile robot 10, but is not limited thereto, and may include a series of processes for charging the mobile robot 10. For example, the charging mode may include, receiving a charging command, autonomous movement to a charging station or docking port, completion of physical connection with a charging terminal or alignment with a wireless charging point, reception of a charging start signal and actual initiation of charging, real-time monitoring and server reporting of battery state during charging (for example, SOC, voltage, current, etc.), and may also include operations such as returning to work after charging is complete or transitioning to standby mode.

On the other hand, based on determining that the operational state of the mobile robot 10 is the task execution state, the first processor 100 may perform control so that the supply of power to the drive unit 101 is not cut off, to thereby maintain the supply of power to the drive unit 101. Specifically, the first processor 100 may control the drive relay 102 to keep the relay circuit closed so that the relay circuit does not transition to an open state.

FIG. 3 is a diagram showing an example of a block configuration of a mobile robot power control system according to an implementation of the present disclosure. Referring to FIG. 3, the mobile robot power control system according to the present implementation may include the mobile robot 10 and a server 20. Detailed configurations included in the mobile robot 10 and operations thereof are the same as the above-description, and repetitive description will be omitted. Hereinafter, the power control of the mobile robot 10 based on the server 20 will be mainly described.

The server 20 may correspond to a computing system that indirectly controls the operation of the drive unit 101 or the battery management system 201, e.g., by transmitting a control command to the first processor 100 or the second processor 200. The server 20 may correspond to a central control unit that performs the power control of the mobile robot 10 externally. The server 20 may be physically implemented as one or more computing devices, such as an industrial control server, a cloud server, or a local gateway device, and may include a configuration connected to the mobile robot 10 through a communication network. The server 20 may internally include one or more processors, memories, communication interfaces, and storage devices. In some implementations, the server 20 may be connected to a plurality of mobile robots 10 at the same time, may monitor the overall operational state comprehensively, and may generate individual or batch power control commands depending on situations. For example, the server 20 may transmit a command for batch control of the plurality of mobile robots 10 to the first processor 100 or the second processor 200.

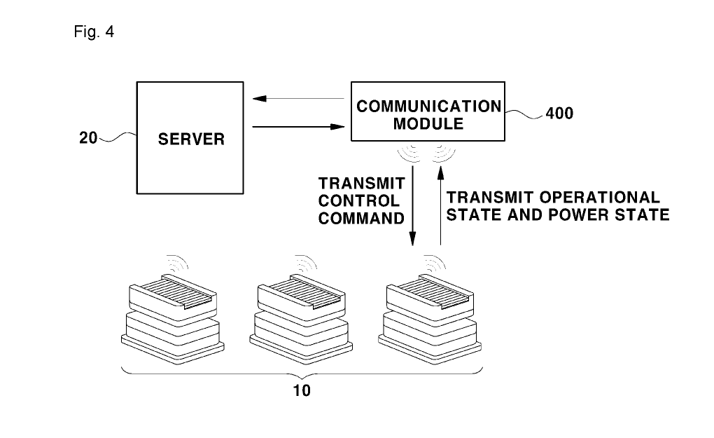

A communication module 400 may correspond to a network interface configuration for transmitting and receiving data between the server 20 and the mobile robot 10. The communication module 400 may transmit and receive data such as operational state information, power state information, and control commands in association with the communication module 300 of the mobile robot 10. For example, the communication module 400 may maintain a real-time connection state with the plurality of mobile robots 10 through wireless communication based on the MQTT protocol, and may minimize network delay or communication load through a lightweight message structure. The communication module 400 may be physically implemented as one or more wireless communication circuits, for example, 5G, Wi-Fi or LoRa-based communication module. The communication module 400 may be implemented as a structure that is integrated into the server 20 (as shown in the example of FIG. 3) or associated with an external gateway device (as shown in the example of FIG. 4).

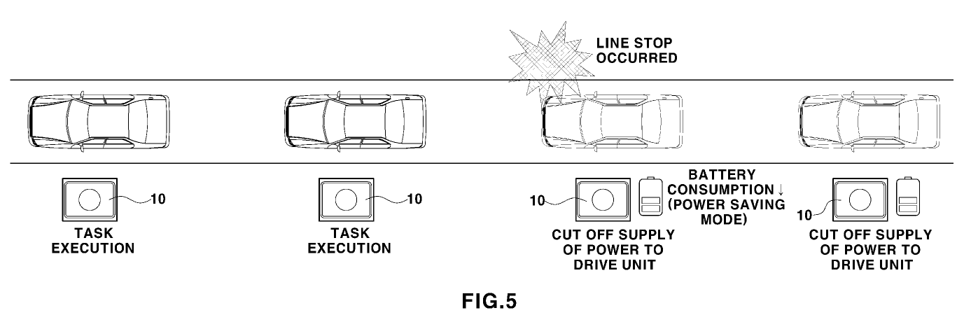

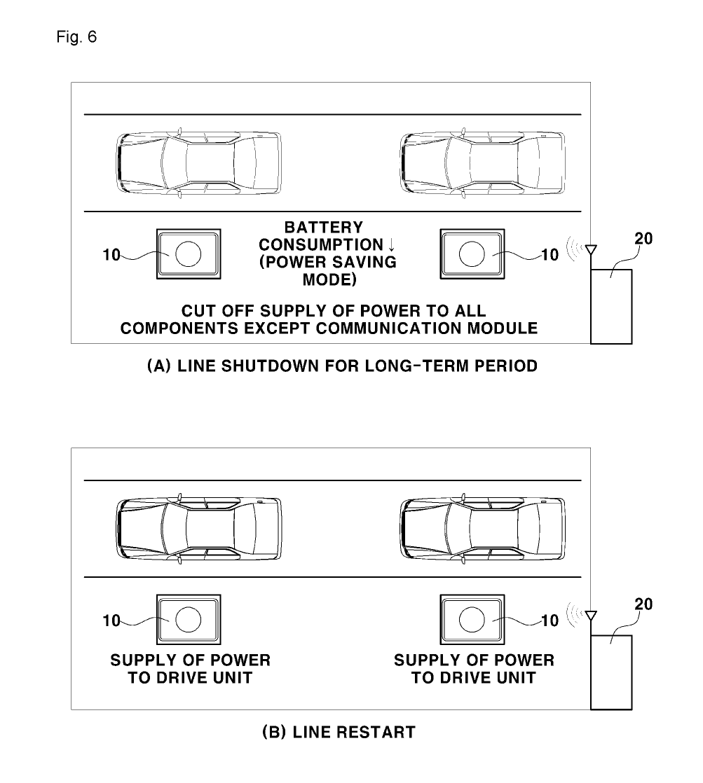

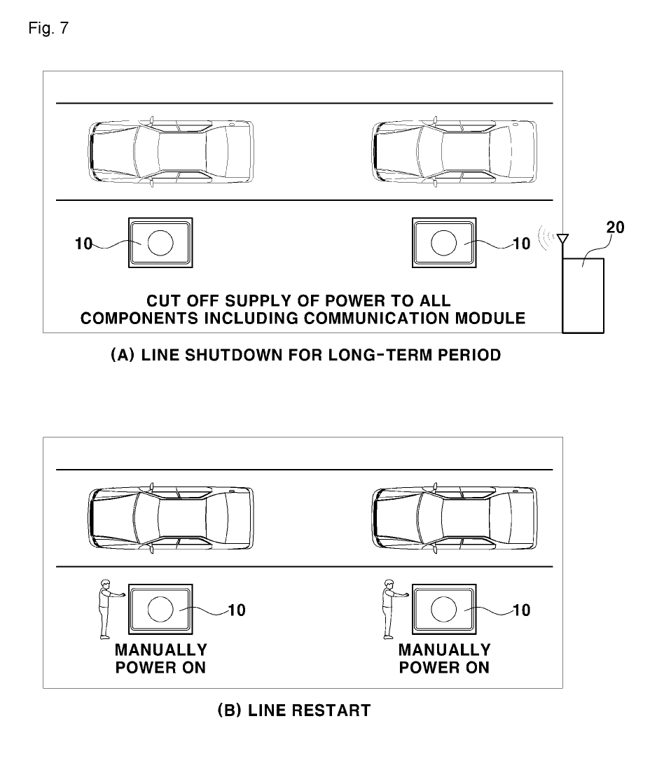

FIG. 4 is a diagram illustrating an example of a mobile robot power control system according to an implementation of the present disclosure, and FIGS. 5 - 7 are diagrams showing examples of the mobile robot power control system according to an implementation of the present disclosure.

Referring to FIG. 4, the server 20 can receive various status information from the mobile robot(s) 10, analyze the status information, and transmit control commands to the mobile robot(s) 10. Specifically, according to implementations of the present disclosure, the server 20 may receive information regarding the operational state and the power state of one or more mobile robots 10, e.g., in real time. The server 20 may determine a power supply control for the mobile robots 10 based on information on the received operational state and power state. Depending on the result, for example, the server 20 may transmit a power-off command or a power supply command to the first processor 100 for the drive unit 101 of the mobile robot(s) 10, and/or may transmit a request to the second processor 200 of the mobile robot(s) 10 to stop or return the operation of the battery management system 201.

As a specific example, in a case where the operational state of the mobile robot 10 is determined as the task execution state, the server 20 may maintain the supply of power to the drive unit 101, e.g., by not transmitting the power-off command to the first processor 100 of the mobile robot 10.

On the other hand, in a case where the operational state of the mobile robot 10 is the standby state, the server 20 can perform control for cutting off the supply of power to one or more (or all) components of the mobile robot 10. In some implementations, cutting off the supply of power can be performed at different levels or for different components of the mobile robot 10, depending on whether the standby state has exceeded one or more reference times, as described below.

For example, if the standby state is maintained for more than a first reference time, the server 20 may perform control for cutting off the supply of power to the drive unit 101 in order to improve the energy efficiency of the mobile robot 10 (FIG. 5). Here, the first reference time may be determined by accumulating the elapsed time from when the operational state was determined to be in the standby state. Whether the standby state is maintained for more than the first reference time may be determined through a predetermined condition comparison logic in the server 20. The first reference time may generally be set to a short duration, for example within tens of minutes, which may be utilized as a criterion for managing single-occurrence events, such as temporary stop, standby, or momentary work intervals of the mobile robot 10. The first reference time can be flexibly configured according to different situations.

Additional references times can also be configured, such as a second reference time and a third reference time. The second and third reference times can be distinguished from the first reference time, in that the second and third reference times correspond to longer-term non-operating states (to be described further below). For example, the second reference time can correspond to a longer duration than the first reference time (e.g., in terms of hours) and the third reference time can correspond to a duration even longer than the second reference time (e.g., in terms of days).

As such, the first reference time can be used as a reference value for precise and immediate power saving control. Thus, in a case where the standby state of the mobile robot 10 is maintained for more than the first reference time, the server 20 may only cut off the supply of power to the drive unit 101 by transmitting a power-off command to the first processor 100. Details of the power cutoff of the drive unit 101 by the first processor 100 and the drive relay 102 have been described, and repetitive description thereof will be omitted.

In a case where the above-mentioned event occurs in a specific work section of a production line, the server 20 may also determine whether to apply the first reference time to the mobile robot 10 that is in the standby state at the next work section. Based on the determination result, the server 20 may also cut off the supply of power to the drive unit 101 of the mobile robot 10, which is in the standby state at the subsequent section.

In a case where the operational state of the mobile robot 10 is the standby state and the standby state is maintained for more than the second reference time, the server 20 may determine the operational state or the standby state of the mobile robot 10 as a long-term non-operating state. In a case where the operational state or the standby state of the mobile robot 10 is determined as the long-term non-operating state, the server 20 may transmit a power-off command. The power-off command may be received by the second processor 200 to cut off the supply of power to the remaining components except the communication module 300 included in the mobile robot (see (A) of FIG. 6).

In some implementations, the second reference time may be a time period during which the mobile robot 10 does not continuously perform any work without receiving any external command such as an operating command or a charging command. The second reference time may correspond to a time longer than the first reference time (for example, several hours or more), and may be adjusted flexibly according to a process plan.

In a case where the standby state of the mobile robot 10 is maintained for more than the second reference time and is determined to be in the long-term non-operating state, the server 20 may generate a power-off command to minimize the energy consumption of the mobile robot 10, and may transmit the command to the second processor 200. In some implementations, the second processor 200 may control an output operation of the battery management system 201 in accordance with the received power-off command. Based on the output of the battery management system 201, the supply of power to the components included in the mobile robot 10 except the communication module 300 may be cut off.

As a specific example, referring back to FIG. 1, the second processor 200 may transition a relay control signal to a low or off state by controlling a digital output (DIO) signal line connected to the battery management system 201. Thus, a pack sub power output (for example, 24V/0.8A) output from the battery module (BAT) may be supplied to the communication module 300, and the circuit may be disconnected to prevent voltage from being supplied to the remaining components of the mobile robot 10, such as the drive unit 101, the sensors, the control units, and the like.

As will be described further below, in a case where conditions for charging or operation restart for the mobile robot 10 are satisfied, the server 20 may output a command instructing supply of power to the drive unit 101 through the first processor 100. As the drive unit 101 is supplied with power through the first processor 100, the production line may be re-operated (see (B) of FIG. 6).

In a case where the operations of all of the plural mobile robots 10 are suspended, based on determining that the operation suspended state is maintained for more than the third reference time, the server 20 may transmit a power-off command. In accordance with the power-off command, the first processor 100 and the second processor 200 may cut off supply of power to all the components included in the plural mobile robots 10 (see (A) of FIG. 7).

In some implementations, the operation suspended state may be a state in which each of the plural mobile robots 10 remains inactive for a certain period of time without performing any active operation such as task execution or standby. The operation suspended state may include cases where a general system shutdown is scheduled, such as a factory-wide long-term holiday, line shutdown, or non-working hours at night. The third reference time can be a reference value for identifying a situation in which the system is suspended for an extended period, which may be flexibly set as a time value of several days or tens of hours or more. The server 20 may monitor, e.g., continuously, the operational state of each of the plural mobile robots 10. Based on determining that all the mobile robots 10 have not operated over the third reference time, it may be determined that the power cutoff condition is satisfied.

In some implementations, the server 20 may transmit a command to the first processor 100 to cut off the supply of power to the drive unit 101, and at the same time may transmit a command to the second processor 200 to stop the operation of the battery management system 201. In such scenarios, the supply of power to the entire components including the drive unit 101, the sensor, the control unit, the communication module 300 and other peripherals included in the plural mobile robots 10 may be entirely disconnected.

The server 20 may output information, to a user, regarding the power-off of all the plural mobile robots 10. For example, in a case where the supply of power to all the circuits including the communication module 300 of the mobile robot 10 is cut off, the communication with the external system or server 20 may be disconnected. In such scenarios, the server 20 may inform the user that a widespread power cut situation has occurred through information output.

The server 20 may output the information to the user through a user device (for example, a monitor, a notification window, or a pop-up window) or an interface connected to a higher-level control system. The output information may include, for example, messages such as “Supply of power to all mobile robot power cut”, “Supply of power to components including communication module cut” or “Manual restart required”. The user may check the output information, and may access the site directly to manually restore the supply of power to each mobile robot 10 or may take appropriate measures to restart the entire system (see (B) of FIG. 7).

The server 20 may periodically monitor the power state of the mobile robot 10, in a state where at least one of the supply of power to the drive unit 101 or the operation of the battery management system 201 is controlled. For example, the server 20 may be connected to the communication module 300 of the mobile robot 10 via the communication module 400, and may periodically receive power-related information such as SoC (State of Charge) of battery, output voltage, or current.

Based on determining that the power state of the received mobile robot 10 decreases below a threshold, the server 20 may determine that charging for the mobile robot 10 is necessary. For example, a case where the SOC decreases below 20% or the voltage drops below a specific reference voltage may be defined as the threshold, that is, a critical situation, but the threshold (critical situation) may be set differently depending on a system administrator or an operational environment.

The server 20 may transmit a control command to the first processor 100 to supply power to the drive unit 101. For example, in a case where the supply of power to the drive unit 101 is cut off as the standby state of the mobile robot 10 is maintained for more than the first or second reference time, the server 20 may restart the supply of power to the drive unit 101 via the first processor 100 for the operation of the mobile robot 10.

The server 20 may transmit a charging command to the mobile robot 10 or transmit a trigger signal instructing autonomous movement to a charging location. The charging method may include wired and/or wireless charging methods, and the mobile robot 10 may move to a designated charging location and perform a charging process according to a command of the server 20. After reaching the charging location, the first processor 100 may secure a location aligned with a charging terminal or a wireless charging coil while maintaining the supply of power to the drive unit 101 via the drive relay 102.

On the other hand, in a case where the operational state of the mobile robot 10 transitions from the standby state to the task execution state, the server 20 may transmit a control command to the first processor 100 to supply power to the drive unit 101 to allow the mobile robot 10 to restart its operation. Specifically, as described above, in a case where the mobile robot 10 is maintained in the standby state without operation for more than a certain amount of time, the supply of power to the drive unit 101 may be cut under the control of the server 20. In this state, in a case where a condition under which the operational state of the mobile robot 10 transitions to a task execution state (for example, input of a task execution command from an external system (for example, MES, WMS, etc), return to task after charging completion) is satisfied, the server 20 may restart the operation of the robot automatically.

For example, the server 20 may transmit a control command including an enable signal or a wake-up command to the first processor 100. The first processor 100 may, after receiving the control command, control the drive relay 102 to put the relay circuit in a closed state. The drive unit 101 may be powered again, so that the mobile robot 10 may restart the work requested.

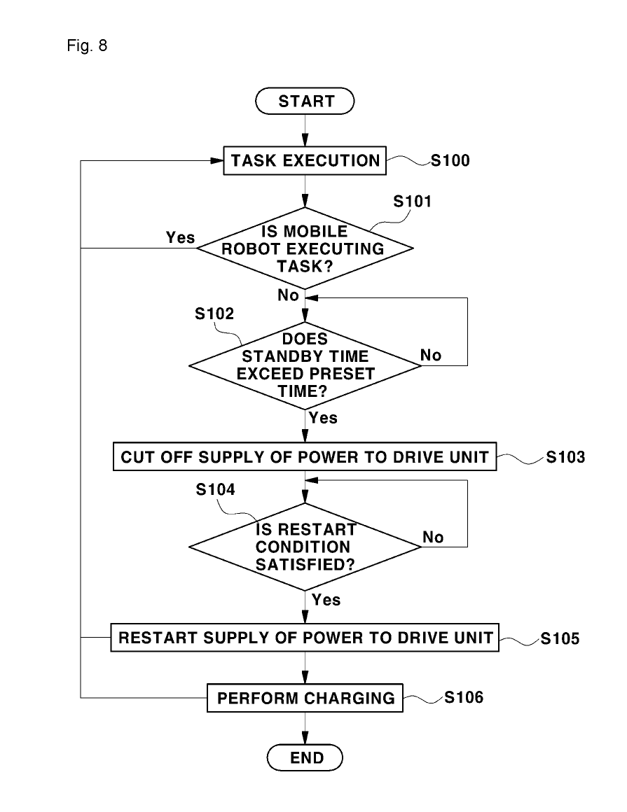

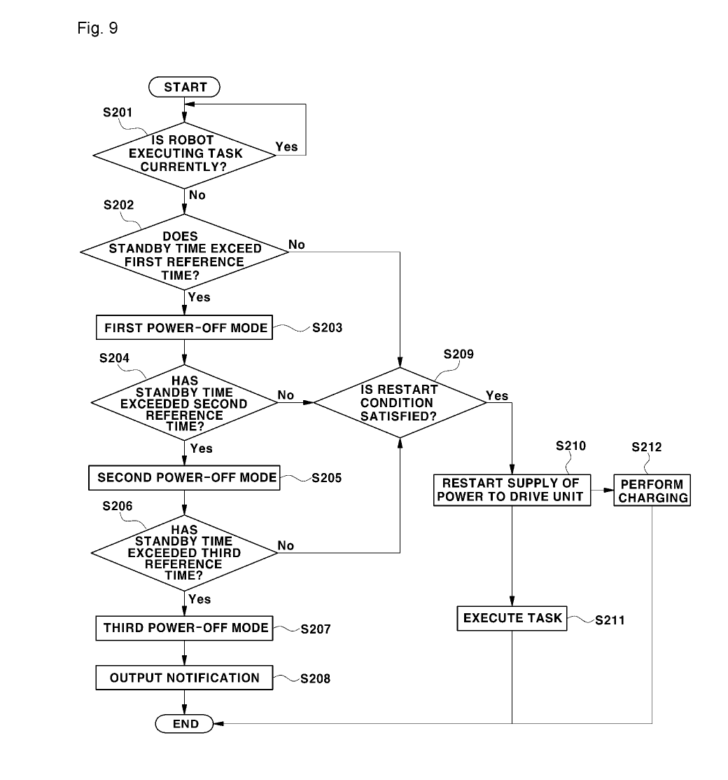

Hereinafter, examples of a mobile robot power control method according to an implementation of the present disclosure will be described with reference to FIGS. 8 and 9, and redundant description overlapping with the above description will be omitted, and the description will focus on a time-series configuration.

Referring to FIG. 8, the first processor 100 of the mobile robot power control method according to the present implementation may determine a current operational state of the mobile robot 10 (S101). According to the determination in step S101, in a case where the current operational state of the mobile robot 10 is the standby state (e.g., not executing a task), the first processor 100 may determine whether the standby state is maintained for more than a reference time (S102). In a case where the standby state of the mobile robot 10 is maintained for more than the reference time, the first processor 100 may cut off the supply of power to the drive unit 101 of the mobile robot 10 (S103). With the supply of power to the drive unit 101 disconnected, the first processor 100 and the second processor 200 may monitor the operational state and the power state of the mobile robot 10. The first processor 100 and the second processor 200 may determine whether a restarting condition (for example, task execution request or charging request) of the mobile robot 10 is satisfied (S104). In a case where the restarting condition of the mobile robot 10 is satisfied, the first processor 100 may restart the supply of power to the drive unit 101 (S105), and thus, the mobile robot 10 may perform the requested work or perform charging (S106).

In some implementations, prior to S101, a process of preferentially determining whether the mobile robot 10 is set to an automatic control mode may be performed. The automatic control mode may involve the mobile robot 10 monitoring the current operational state and power state by itself and performing processes such as cutoff of the supply of power to the drive unit 101 or restart of the supply of power. Thus, in a case where the mobile robot 10 is in the automatic control mode, the above-described steps (S100 to S106) may be performed, but in a case where the mobile robot 10 is in a manual control mode rather than the automatic control mode, a more user-interactive procedure can be performed, such as a process of outputting information on the current operational state of the mobile robot 10 to the user. In such scenarios, for example, the mobile robot 10 may not control the supply of power to the drive unit 101 by itself based on the operational state or the power state, but may only output the information on the real-time operational state or power state to the user.

Referring to FIG. 9, in an example of a mobile robot power control method according to another implementation of the present disclosure, the server (e.g., server 20 in FIG. 3) may receive a current operational state of each of the plurality of mobile robots 10, and may determine whether the mobile robot 10 is currently under task execution (S201).

In a case where the mobile robot 10 is in the standby state (not currently executing a task) and if the standby state is maintained for more than a first reference time (S202), the server 20 may start a first power cutoff mode. For example, the first power cutoff mode can include cutting off the supply of power to only some of the components, such as the drive unit 101, of the mobile robot (S203).

Subsequently, in a case where the standby state of the mobile robot 10 is maintained for more than a second reference time (S204), the server 20 may start a second power cutoff mode. The second power cutoff mode can include cutting off the supply of power to additional components, such as all components except the communication module 300, of the mobile robot (S205).

Furthermore, in a case where the standby state of the mobile robot 10 is maintained for more than a third reference time (S206), the server 20 may start a third power cutoff mode. The third power cutoff mode can include cutting off the supply of power to all components including the communication module 300 of the mobile robot (S207). In some implementations, in a case where the third power cutoff mode is executed, the server 20 may display a notification to the user. The user may restart the operation of the mobile robot 10 manually by direct intervention, as necessary (S208).

On the other hand, in a case where the mobile robot 10 is currently in the standby state, but the standby state is not maintained for more than one of the first reference time (“NO” in S202), the second reference time (“NO” in S204), or the third reference time (“NO” in S206), the server 20 may determine whether the mobile robot 10 satisfies the restart condition (S209). In this scenario, the restart condition may include a case in which a task execution request or a charging request is received by the mobile robot 10 (S209).

In a case where the restart condition is satisfied, the server 20 may perform control for re-powering the drive unit 101 of the mobile robot 10 (S210). As the drive unit 101 is re-supplied with power, the mobile robot 10 may perform the requested task (S211). On the other hand, in a case where the power state of the mobile robot 10 falls below a threshold, the server 20 may perform charging of the mobile robot 10 (S212).

The above-described implementations may be implemented by methods or processes, apparatuses, software programs, or data streams or signals. Although discussed only in the context of a single form of the implementation (for example, only as a method), the implementation of the described features may also be achieved in other forms (for example, apparatuses or programs). The apparatus may be implemented with appropriate hardware, software, and firmware. The method may be implemented in an apparatus such as a processor, which generally refers to a processing device including, for example, a computer, a microprocessor, an integrated circuit or a programmable logic device. The processor may also include a communication device such as computers, cell phones, and personal digital assistants (PDA) and other devices that allow information communication between end-users.

The disclosure has been described in detail with reference to preferred implementations thereof. However, it will be appreciated by those skilled in the art that changes may be made in these implementations without departing from the principles and spirit of the disclosure, the scope of which is defined in the appended claims and their equivalents.

What is claimed is:

1. A mobile robot power control apparatus comprising:
at least one processor; and
at least one memory storing computer program instructions that, based on being executed by the at least one processor, perform operations comprising:
controlling a supply of power to a drive unit of a mobile robot;
controlling an operation of a battery management system for the mobile robot; and
based on an operational state of the mobile robot:
determining at least one signal among (i) a first signal to control the supply of power to the drive unit and (ii) a second signal to control the battery management system, to cut off the supply of power to the drive unit; and
transmitting the at least one signal to cut off the supply of power to the drive unit.

2. The apparatus according to claim 1, wherein the operations further comprise:
based on determining that the operational state of the mobile robot is a standby state and the standby state is maintained for more than a reference time, providing the first signal that controls a drive relay connected to the drive unit and cuts off the supply of power to the drive unit.

3. The apparatus according to claim 1, wherein the operations further comprise:
in a state where the supply of power to the drive unit is cut off, monitoring a power state of the mobile robot, and transmitting a third signal to re-start the supply of power to the drive unit based on the power state of the mobile robot.

4. The apparatus according to claim 3, wherein the operations further comprise:
based on determining that the power state is equal to or lower than a threshold, re-starting the supply of power to the drive unit to perform a charging mode of the mobile robot.

5. The apparatus according to claim 1, wherein the operations further comprise:
based on determining that the operational state of the mobile robot is a task execution state, performing control so that the supply of power to the drive unit is not cut off to maintain the supply of power to the drive unit.

6. A mobile robot power control system comprising:
a server computing system; and
mobile robot power control apparatus that includes at least one processor and at least one memory storing computer program instructions that, based on being executed by the at least one processor, perform operations comprising:
controlling supply of power to a drive unit of a mobile robot;
controlling an operation of a battery management system for the mobile robot; and
based on at least one control command of the server computing system, and based on an operational state of the mobile robot:
generating at least one signal among (i) a first signal to control the supply of power to the drive unit and (ii) a second signal to control the battery management system, to cut off the supply of power to the drive unit.

7. The system according to claim 6, wherein the at least one control command of the server computing system comprises a command for controlling a plurality of mobile robots in a batch.

8. The system according to claim 6, wherein, based on determining that the operational state of the mobile robot is a task execution state, the at least one control command of the server computing system does not include a power-off command, based on which the mobile robot power control apparatus maintains the supply of power to the drive unit.

9. The system according to claim 6, wherein, based on determining that the operational state of the mobile robot is a standby state and the standby state is maintained for more than a first reference time:
the at least one control command of the server computing system includes a power-off command for cutting off the supply of power to the drive unit, and
the mobile robot power control apparatus generates the first signal that controls a drive relay connected to the drive unit based on the power-off command to cut off the supply of power to the drive unit.

10. The system according to claim 6, wherein, based on determining that the operational state of the mobile robot is a standby state, and the standby state is maintained for more than a second reference time and is a long-term suspended state:
the at least one control command of the server computing system includes a power-off command for cutting off the supply of power to the drive unit,
the mobile robot power control apparatus generates the first signal that controls a drive relay connected to the drive unit based on the power-off command, to cut off the supply of power to the drive unit, and
the mobile robot power control apparatus generates the second signal that controls the battery management system based on the power-off command to cut off the supply of power from a battery to the drive unit.

11. The system according to claim 7, wherein, based on determining that the operational states of all the plurality of mobile robots are in suspended states, and the suspended states maintain over a third reference time, the at least one control command of the server computing system include a power-off command for cutting off the supply of power of the plurality of mobile robots, and the at least one control command is transmitted to each of the plurality of mobile robots.

12. The system according to claim 11, wherein the server computing system is configured to output information, to a user, regarding cutting off the supply of power of the plurality of mobile robots.

13. The system according to claim 6, wherein the server computing system is configured to periodically monitor, in a state where at least one of the supply of power to the drive unit or the operation of the battery management system is controlled, a power state of the mobile robot.

14. The system according to claim 13, wherein, based on determining that the power state is equal to or lower than a threshold, the at least one control command of the server computing system includes a control command that causes the mobile robot power control apparatus to generate the first signal to supply power to the drive unit, and to perform control for charging the mobile robot.

15. The system according to claim 6, wherein in a case where the operational state of the mobile robot transitions from a standby state to a task execution state:
the at least one control command of the server computing system includes a control command instructing supply of power to the drive unit,
the mobile robot power control apparatus generates the first signal that controls a drive relay connected to the drive unit based on the control command instructing the supply of power to supply power to the drive unit, and
the mobile robot power control apparatus generates the second signal that controls the battery management system based on the control command instructing the supply of power to supply power from a battery to the drive unit.

16. A mobile robot power control method performed by a computing system, the method comprising:
receiving an operational state and a power state of each of a plurality of mobile robots;
based on at least one of the operational state or the power state of at least one mobile robot among the plurality of mobile robots, generating at least one control command among (i) a first control command for controlling a supply of power to a drive unit of the at least one mobile robot and (ii) a second control command for controlling an operation of a battery management system of the at least one mobile robot, ; and
transmitting the at least one control command to a specific mobile robot or all the plurality of mobile robots.

17. The method according to claim 16, wherein the generating the at least one control command comprises:
generating, based on determining that the operational state of the mobile robot is a standby state and the standby state is maintained for more than a reference time, (i) the first control command for cutting off the supply of power to the drive unit of the mobile robot, or (ii) the second control command for cutting off supply of power to remaining components except a communication module included in the mobile robot by controlling the operation of the battery management system of the mobile robot.

18. The method according to claim 17, wherein the generating the at least one control command further comprises:
transmitting, to each of the plurality of mobile robots based on determining that the operational states of the plurality of mobile robots are in suspended states and the suspended states are maintained for more than a reference time, a power-off command for cutting off power of all of the plurality of mobile robots.

19. The method according to claim 17, wherein the generating the at least one control command further comprises:
generating, based on determining that the operational state of the mobile robot transitions from the standby state to a task execution state, a control command for supplying power to the drive unit.

20. The method according to claim 16, wherein the generating the at least one control command further comprises:
generating the at least one control command to start a charging mode for the mobile robot, based on determining that the power state falls below a threshold.
